(19) United States
(12) Patent Application Publication
(10) Pub. No.: US 2005/0041939 A1
(43) Pub. Date: Feb. 24, 2005

(54) Method and apparatus for processing edge surfaces of optical fibers, and method and apparatus for fusion splicing optical fibers

(75) Inventors: Shigeru Saito, Chiba (JP); Noriyuki Kawanishi, Chiba (JP); Yoshinori Kanai, Chiba (JP); Hideaki Terauchi, Kawasaki (JP); Osamu Saito, Kawasaki (JP); Shizuo Ishijima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/889,222

(22) Filed: Jul. 13, 2004

(30) Foreign Application Priority Data
Jul. 14, 2003 (JP) 2003-196704(PAT)

(51) Int. Cl. G02B 6/255

(52) U.S. Cl. 385/96

(57) ABSTRACT

An optical fiber edge surface processing method has the steps of capturing a transmitted-light image of end portions of two optical fibers placed facing each other, and extracting, based on a brightness distribution in the transmitted-light image, edge surface information of each of the two optical fibers to be spliced together; selecting a discharge condition corresponding to the edge surface information from among a plurality of discharge conditions prestored in a storage unit; and melting the splicing edge surfaces of the two optical fibers in accordance with the selected discharge condition, and thereby shaping the splicing edge surfaces. With this method, splice loss can be reduced in a simple manner, even when the edge surface angle of each optical fiber, or the relative edge surface angle between the two optical fibers, or the amount of chipping at the splicing cross section of each optical fiber, is large.

### CROSS REFERENCE TO RELATED APPLICATION

This application is based upon and claims the benefit of priority from the prior Japanese Patent Application No. 2003-196704, filed on Jul. 14, 2003, the entire contents of which are incorporated herein by reference.

### BACKGROUND OF THE INVENTION

1. Field of the Invention

The present invention relates to a method and apparatus for processing the edge surfaces of optical fibers, and also relates to a method and apparatus for fusion splicing optical fibers. More particularly, the invention relates to a method and apparatus for processing the edge surfaces of optical fibers, wherein in a process of fusion splicing two optical fibers, an arc discharge having the amount of discharge energy adjusted to match the condition of the edge surface of each fiber is applied to the splicing edge surface of the fiber to melt and shape the splicing edge surface, thereby reducing splice loss attributable to the edge surface condition; the invention also relates to a method and apparatus for fusion splicing the optical fibers.

2. Description of the Related Art

Conventionally, in a process preparatory to fusion splicing two optical fibers, the end face of each fiber is cut and processed to even off the splicing edge surface of the fiber. At this time, there can occur cases where the cut face is not perpendicular to the fiber axis because of the lack of skill of the operator or an adjustment error of the optical fiber cutter.

To address this, there has been proposed a method in which, before fusion splicing the two fibers, an image of the splicing edge surfaces of the two fibers butted against each other is captured using an imaging device, then image processing is performed on the thus captured image of the splicing edge surfaces to obtain edge surface angles and, after performing prescribed processing, an alarm indication is produced, urging the operator to suspend the splicing operation, or the splicing operation is forcefully terminated. Specifically, Japanese Unexamined Patent Publication (Kokai) No. 08-327851, for example, discloses a method for reducing the effect of the relative edge surface angle on splice loss.

The prior art and its associated problems will be described in detail later with reference to attached drawings.

### SUMMARY OF THE INVENTION

An object of the present invention is to provide a method and apparatus for processing the edge surfaces of optical fibers, wherein even when the edge surface angle of each of the two fibers to be spliced together, or their relative edge surface angle, has a large value, splice loss can be reduced in a simple manner by melting and shaping the splicing edge surfaces without suspending the splicing operation; another object of the invention is to provide an optical fiber fusion splicing method and apparatus for fusion splicing the optical fibers in a short time, after the above processing has been performed.

According to a first aspect of the present invention, there is provided an optical fiber edge surface processing method comprising capturing a transmitted-light image of end portions of two optical fibers placed facing each other, and extracting, based on a brightness distribution in the transmitted-light image, edge surface information of each of the two optical fibers to be spliced together; selecting a discharge condition corresponding to the edge surface information from among a plurality of discharge conditions prestored in a storage means; and melting the splicing edge surfaces of the two optical fibers in accordance with the selected discharge condition, thereby shaping the splicing edge surfaces.

According to the optical fiber edge surface processing method in the first aspect of the present invention, after capturing the transmitted-light image of the end portions of the two optical fibers placed facing each other, edge surface information of each of the two optical fibers to be spliced together is extracted based on the brightness distribution in the transmitted-light image. Then, the discharge condition corresponding to the extracted edge surface information is selected from among the plurality of discharge conditions prestored in the storage means, and the splicing edge surfaces of the two optical fibers are melted and shaped in accordance with the selected discharge condition. In this way, since the fiber edge surface condition that affects the splice loss is automatically extracted, and the optimum discharge condition is selected in accordance with the edge surface condition, the splice loss can be reduced in a simple manner.

In a preferred mode, the edge surface information concerns an edge surface angle that the splicing edge surface of each of the optical fibers makes with a plane perpendicular to the axial center of the optical fiber, and the discharge condition defines the amount of discharge energy necessary to melt the splicing edge surface of the optical fiber so as to reduce splice loss attributable to the edge surface angle. According to this optical fiber edge surface processing method, the following effect is offered in addition to the effect of the first aspect of the present invention. That is, the edge surface information corresponds to the edge surface angle that the splicing edge surface of each optical fiber makes with a plane perpendicular to the axial center of the optical fiber, and the discharge condition corresponds to the amount of discharge energy necessary to melt the splicing edge surface of the optical fiber so as to reduce the splice loss attributable to the edge surface angle. Therefore, by melting and shaping the splicing edge surface of each optical fiber by using an arc discharge, the splice loss attributable to the edge surface angle can be reduced in a simple manner.

Here, the amount of discharge energy may be made to vary continuously or in steps in correlation with the magnitude of the edge surface angle. According to this optical fiber edge surface processing method, since the amount of discharge energy varies continuously or in steps in correlation with the magnitude of the edge surface angle, the amount of discharge energy necessary to eliminate the effect of the edge surface angle on the splice loss can be determined uniquely.

In a preferred mode, the edge surface information concerns a relative edge surface angle which represents a difference between a first edge surface angle that the splicing edge surface of one of the two optical fibers makes with a plane perpendicular to the axial center of that one optical fiber and a second edge surface angle that the splicing edge surface of the other optical fiber makes with a plane perpendicular to the axial center of that other optical fiber, and the discharge condition defines the amount of discharge energy necessary to melt the splicing edge surface of that one optical fiber and the splicing edge surface of that other optical fiber so as to reduce splice loss attributable to the relative edge surface angle. According to this optical fiber edge surface processing method, the following effect is provided in addition to the effect of the first aspect of the present invention. That is, the edge surface information corresponds to the relative edge surface angle which represents the difference between the first edge surface angle that the splicing edge surface of one of the two optical fibers makes with a plane perpendicular to the axial center of that one optical fiber and the second edge surface angle that the splicing edge surface of the other optical fiber makes with a plane perpendicular to the axial center of that other optical fiber. On the other hand, the discharge condition corresponds to the amount of discharge energy necessary to melt the splicing edge surface of that one optical fiber and the splicing edge surface of that other optical fiber so as to reduce the splice loss attributable to the relative edge surface angle. Therefore, by melting and shaping the splicing edge surfaces of the two optical fibers by using an arc discharge, the splice loss attributable to the relative edge surface angle can be reduced in a simple manner.

Here, the amount of discharge energy may be made to vary continuously or in steps in correlation with the magnitude of the relative edge surface angle. According to this optical fiber edge surface processing method, since the amount of discharge energy varies continuously or in steps in correlation with the magnitude of the relative edge surface angle, the amount of discharge energy necessary to eliminate the effect of the relative edge surface angle on the splice loss can be determined uniquely.

In a preferred mode, the edge surface information concerns the amount of chipping at the splicing edge surface of each of the optical fibers, and the discharge condition defines the amount of discharge energy necessary to melt the splicing edge surface of the optical fiber so as to reduce splice loss attributable to the amount of chipping. According to this optical fiber edge surface processing method, the following effect is provided in addition to the effect of the first aspect of the present invention. That is, the edge surface information corresponds to the amount of chipping, and the discharge condition corresponds to the amount of discharge energy necessary to melt the splicing edge surface of the optical fiber so as to reduce the splice loss attributable to the amount of chipping. Therefore, by melting and shaping the splicing edge surface of each optical fiber by using an arc discharge, the splice loss attributable to the amount of chipping can be reduced in a simple manner.

Here, the amount of discharge energy may be made to vary continuously or in steps in correlation with the magnitude of the amount of chipping. According to this optical fiber edge surface processing method, since the amount of discharge energy varies continuously or in steps in correlation with the magnitude of the amount of chipping, the amount of discharge energy necessary to eliminate the effect of the amount of chipping on the splice loss can be determined uniquely.

According to a second aspect of the present invention, there is provided an optical fiber edge surface processing apparatus comprising image capturing means for capturing a transmitted-light image of end portions of two optical fibers; information extracting means for extracting edge surface information of each of the two optical fibers based on a brightness distribution in the transmitted-light image; storage means for prestoring a plurality of discharge conditions; selecting means for selecting a discharge condition corresponding to the edge surface information from among the plurality of discharge conditions; and processing means for melting the splicing edge surfaces of the two optical fibers in accordance with the discharge condition selected by the selecting means, and thereby shaping the splicing edge surfaces.

According to the optical fiber edge surface processing apparatus in the second aspect of the present invention, the information extracting means extracts the edge surface information of the two optical fibers from the transmitted-light image of the end portions of the two optical fibers captured by the image capturing means. After that, the selecting means selects the discharge condition corresponding to the extracted edge surface information from among the plurality of discharge conditions stored in the storage means, and the processing means melts and shapes the splicing edge surfaces of the two optical fibers in accordance with the selected discharge condition. In this way, since the fiber edge surface condition that affects the splice loss is automatically extracted, and the optimum discharge condition is selected in accordance with the edge surface condition, the splice loss can be reduced in a simple manner.

According to a third aspect of the present invention, there is provided an optical fiber fusion splicing method for fusion splicing two optical fibers together, comprising capturing a transmitted-light image of end portions of the two optical fibers placed facing each other, and extracting, based on a brightness distribution in the transmitted-light image, edge surface information of each of the two optical fibers to be spliced together; selecting a splicing condition corresponding to the edge surface information from among a plurality of splicing conditions prestored in a storage means; and producing a preliminary arc discharge in accordance with the selected splicing condition, thereby melting and shaping the splicing edge surfaces of the two optical fibers.

According to the optical fiber fusion splicing method in the third aspect of the present invention, after capturing the transmitted-light image of the end portions of the two optical fibers placed facing each other, edge surface information of each of the two optical fibers to be spliced together is extracted based on the brightness distribution in the transmitted-light image. Then, the splicing condition corresponding to the extracted edge surface information is selected from among the plurality of splicing conditions prestored in the storage means, and the splicing edge surfaces of the two optical fibers are melted and shaped by producing a preliminary arc discharge in accordance with the selected splicing condition. In this way, since the fiber edge surface condition that affects the splice loss is automatically extracted, and the splicing edge surfaces of the optical fibers are melted and shaped by applying a preliminary arc discharge based on the optimum discharge condition selected in accordance with the edge surface condition, the two optical fibers can be fusion spliced by reducing the splice loss in a simple manner.

According to a fourth aspect of the present invention, there is provided an optical fiber fusion splicing method for fusion splicing two optical fibers together, comprising capturing a transmitted-light image of end portions of the two optical fibers placed facing each other, and extracting, based on a brightness distribution in the transmitted-light image, edge surface information of each of the two optical fibers to be spliced together; selecting a splicing condition corresponding to the edge surface information from among a plurality of splicing conditions prestored in a storage means; and producing a cleaning arc discharge in accordance with the selected splicing condition, thereby melting and shaping the splicing edge surfaces of the two optical fibers.

According to the optical fiber fusion splicing method in the fourth aspect of the present invention, after capturing the transmitted-light image of the end portions of the two optical fibers placed facing each other, edge surface information of each of the two optical fibers to be spliced together is extracted based on the brightness distribution in the transmitted-light image. Then, the splicing condition corresponding to the extracted edge surface information is selected from among the plurality of splicing conditions prestored in the storage means, and the splicing edge surfaces of the two optical fibers are melted and shaped by producing a cleaning arc discharge in accordance with the selected splicing condition. In this way, since the fiber edge surface condition that affects the splice loss is automatically extracted, and the splicing edge surfaces of the optical fibers are melted and shaped by applying a cleaning arc discharge based on the optimum discharge condition selected in accordance with the edge surface condition, the two optical fibers can be fusion spliced by reducing the splice loss in a simple manner. Furthermore, since the cleaning arc discharge also serves the function of the preliminary arc discharge, the fusion splicing of the two optical fibers can be accomplished in a short time.

According to a fifth aspect of the present invention, there is provided an optical fiber fusion splicing apparatus for fusion splicing two optical fibers together, comprising image capturing means for capturing a transmitted-light image of end portions of the two optical fibers; information extracting means for extracting edge surface information of each of the two optical fibers based on a brightness distribution in the transmitted-light image; storage means for prestoring a plurality of splicing conditions; selecting means for selecting a splicing condition corresponding to the edge surface information from among the plurality of splicing conditions; discharging means for producing an arc discharge to be applied to the splicing edge surfaces of the two optical fibers; and control means for controlling the amount of discharge energy of the arc discharge in accordance with the splicing condition selected by the selecting means.

According to the optical fiber fusion splicing apparatus in the fifth aspect of the present invention, the information extracting means extracts the edge surface information of the two optical fibers from the transmitted-light image of the end portions of the two optical fibers captured by the image capturing means. After that, the selecting means selects the splicing condition corresponding to the extracted edge surface information from among the plurality of splicing conditions stored in the storage means; then, with the amount of discharge energy of the arc discharge controlled by the control means in accordance with the selected splicing condition, the arc discharge is applied from the discharging means to the splicing edge surfaces of the two optical fibers, to fusion splice the two optical fibers. In this way, since the fiber edge surface condition that affects the splice loss is automatically extracted, and the splicing edge surfaces of the optical fibers are melted and shaped by applying thereto an arc discharge based on the optimum splicing condition selected in accordance with the edge surface condition, the two optical fibers can be fusion spliced by reducing the splice loss in a simple manner.

### BRIEF DESCRIPTION OF THE DRAWINGS

The present invention will be more clearly understood from the description of the preferred embodiments as set forth below with reference to the accompanying drawings, wherein:

FIG. 1 is a diagram showing the angle that a cut face of each optical fiber makes with the fiber axis;

FIG. 2 is a diagram for explaining a prior art method for reducing the effect of relative edge surface angle on splice loss;

FIG. 3 is a side view showing an optical fiber splicing apparatus according to an embodiment of the present invention;

FIG. 4 is a plan view of the optical fiber splicing apparatus according to the embodiment of the present invention;

FIG. 5 is a control system block diagram showing a control unit, input-side units, and output-side units according to the embodiment of the present invention;

FIG. 6 is a flowchart for explaining a splicing method according to the embodiment of the present invention;

FIG. 7 is a diagram showing a transmitted-light image of fiber ends according to the embodiment of the present invention;

FIGS. 8A and 8B are diagrams showing the variation of the electric current supplied from a discharge power supply unit and the variation of the moving distance of a bare fiber in a splicing operation according to the embodiment of the present invention;

FIG. 9 is a graph showing the relationship between relative edge surface angle and splice loss in a fiber whose edge surface angle easily tends to affect the splice loss, for two different amounts of discharge energy;

FIG. 10 is a graph showing the relationship between relative edge surface angle and splice loss in a standard single-mode fiber for two different amounts of discharge energy;

FIGS. 11A, 11B, and 11C are diagrams showing the deformation of a fiber joint shape caused by the application of an arc discharge having an excessive amount of discharge energy;

FIG. 12 is a graph showing the relationship between preliminary discharge time and allowable relative edge surface angle according to the embodiment of the present invention; and

FIG. 13 is a flowchart for explaining a splicing method according to a modified example of the embodiment of the present invention.

### DESCRIPTION OF THE PREFERRED EMBODIMENTS

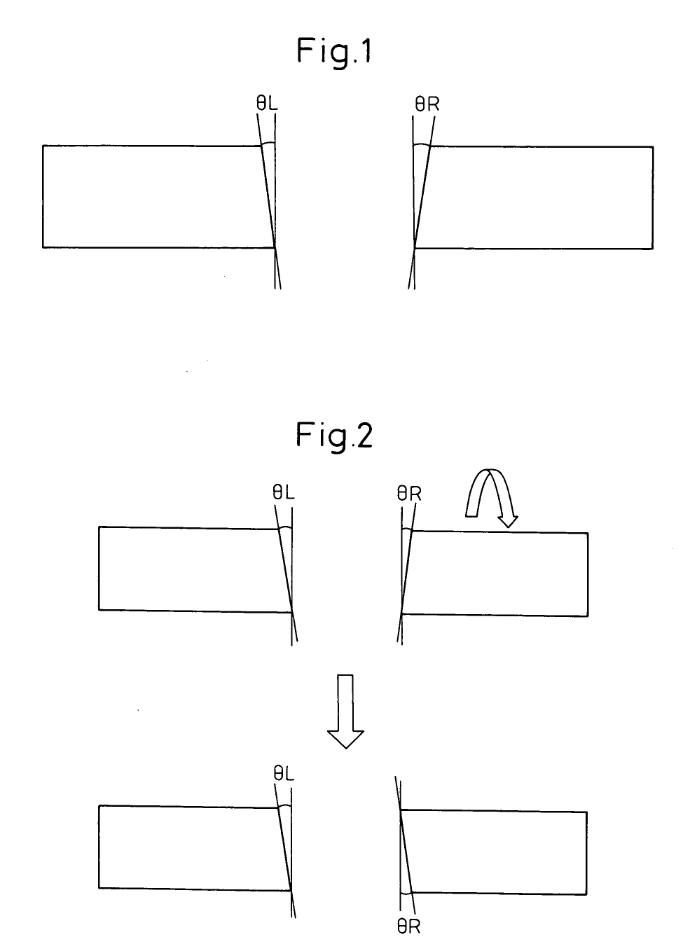

Before describing the embodiments of a method and apparatus for processing the edge surfaces of optical fibers and a method and apparatus for fusion splicing the optical fibers according to the present invention, the prior art and its associated problems will be described with reference to FIGS. 1 and 2.

Conventionally, in a process preparatory to fusion splicing two optical fibers, the end face of each fiber is cut and processed to even off the splicing edge surface of the fiber. At this time, there can occur cases where the cut face is not perpendicular to the fiber axis because of the lack of skill of the operator or an adjustment error of the optical fiber cutter.

FIG. 1 shows edge surface angles θL and θR, each representing the angle that the cut face of a fiber makes with the fiber axis. If, in this condition, the two optical fibers are pushed in and fused together by an arc discharge, there occurs the problem that good splicing performance with low splice loss cannot be obtained. More specifically, since the gap between the splicing edge surface of one fiber and the splicing edge surface of the other fiber is not uniform over their interface, in a small-gap portion the heat of the arc discharge not only becomes excessive but the amount of pushing-in is also large, while in a large-gap portion, not only the heat of the arc discharge but also the amount of pushing-in is insufficient. Accordingly, since the connection condition is not uniform over the entire edge surfaces of the fibers, deformation occurs at the portion where the two optical fibers are joined together.

To solve the above problem, the following method has been used in the prior art. That is, before fusion splicing the two fibers, an image of the splicing edge surfaces of the two fibers butted against each other is captured using an imaging device, after which image processing is performed on the thus captured image of the splicing edge surfaces to obtain the edge surface angles θL and θR. Then, if each of the edge surface angles θL and θR exceeds a prescribed threshold value, or if the absolute value of the difference between the edge surface angles θL and θR, that is, the relative edge surface angle |θL−θR|, exceeds a prescribed threshold value (usually, 2° to 5°), then an alarm indication is produced, urging the operator to suspend the splicing operation, or the splicing operation is forcefully terminated.

Further, to solve the above problem, the method described in Japanese Unexamined Patent Publication (Kokai) No. 08-327851 has also been used in the prior art. FIG. 2 shows a method for reducing the effect of the relative edge surface angle on splice loss, which is disclosed in Japanese Unexamined Patent Publication (Kokai) No. 08-327851. In this method, if the relative edge surface angle |θL−θR| between the fibers exceeds the prescribed threshold value, one of the fibers is held fixed and the other fiber is rotated using a rotational alignment device to minimize the value of the relative edge surface angle |θL−θR|. Using this method, splice loss can be reduced even when the edge surface angles θL and θR are large, because the edge surfaces of the two fibers can be made nearly parallel to each other.

However, in the method that involves producing an alarm indication, urging the operator to suspend the splicing operation, or forcefully terminating the splicing operation, the splicing operation has to be redone by cutting the fiber end once again. Further, if the fiber end portion does not have a sufficient length for cutting, the splicing operation may have to be continued even when the edge surface angle of each fiber is large. In the above method, however, if the edge surface angle of each fiber exceeds the prescribed threshold value, there is the possibility that the splicing operation may be forcefully terminated.

Furthermore, in the method described in Japanese Unexamined Patent Publication (Kokai) No. 08-327851, the relative edge surface angle cannot be reduced unless the splicer is equipped with a rotational alignment mechanism. In addition, the job of minimizing the relative edge surface angle by rotating one of the fibers takes considerable time to accomplish. This further adds to the time required to complete the fiber splicing operation.

The embodiments of a method and apparatus for processing the edge surfaces of optical fibers and a method and apparatus for fusion splicing the optical fibers according to the present invention will be described in detail below with reference to the accompanying drawings.

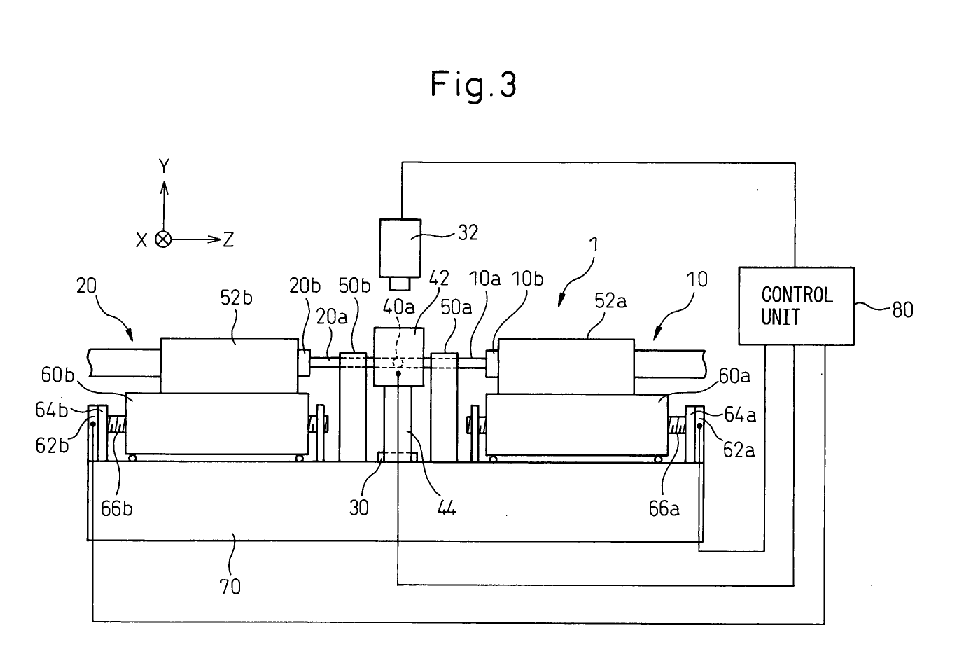

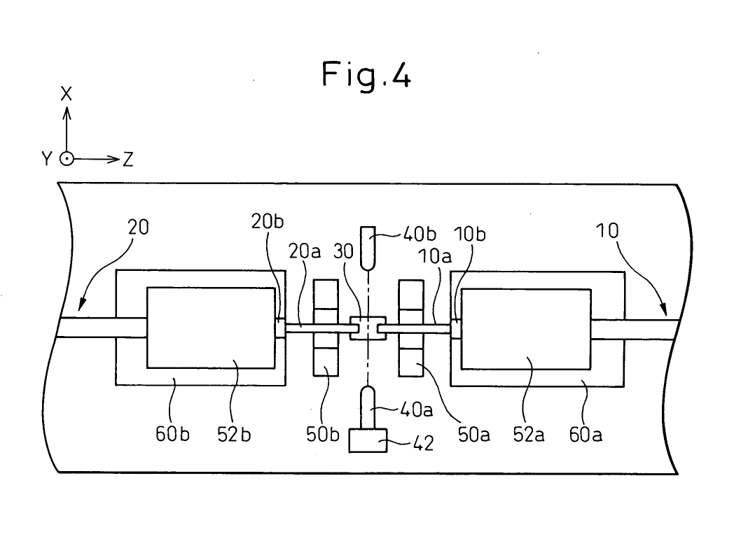

FIG. 3 is a side view showing an optical fiber splicing apparatus 1 according to an embodiment of the present invention. FIG. 4 is a plan view of the optical fiber splicing apparatus 1 according to the embodiment of the present invention. The optical fiber splicing apparatus 1 shown in FIGS. 3 and 4 comprises optical fibers 10 and 20, a light source 30, a CCD camera 32, discharge electrode rods 40a and 40b, a discharge power supply unit 42, a supporting member 44, V grooves 50a and 50b, holders 52a and 52b, moving stages 60a and 60b, Z-axis motors 62a and 62b, reduction gearings 64a and 64b, feed screws 66a and 66b, a base 70, and a control unit 80.

The optical fibers 10 and 20 are fibers comprising bare fibers 10a and 20a covered with sheaths 10b and 20b, respectively.

The moving stages 60a and 60b are mounted on the upper surface of the base 70, and are movable along the Z-axis direction independently of each other. In this embodiment, the fiber axis direction of the optical fibers 10 and 20 is denoted as the Z-axis, and the horizontal direction orthogonal to the Z-axis is taken as the X-axis, while the vertical direction orthogonal to the Z-axis is taken as the Y-axis. To describe briefly the moving mechanism of the moving stages 60a and 60b, when the Z-axis motors 62a and 62b mounted on the upper surface of the base 70 are driven to rotate, the rotational motion is converted into rectilinear motion via the reduction gearings 64a and 64b, thus enabling the feed screws 66a and 66b to move along the fiber axis direction (Z-axis direction) of the optical fibers 10 and 20.

The holders 52a and 52b are for holding the optical fibers 10 and 20, respectively, and are mounted on the upper surfaces of the respective moving stages 60a and 60b.

The bare fibers 10a and 20a, to be spliced, of the optical fibers 10 and 20 held in the respective holders 52a and 52b are placed in the V grooves 50a and 50b, respectively, which are mounted on the upper surface of the base 70. The positions of the V grooves 50a and 50b are preadjusted so that the axes of the bare fibers 10a and 20a are aligned with each other.

The CCD camera 32 is disposed opposite the light source 30 mounted on the base 70, with the end portions of the bare fibers 10a and 20a of the optical fibers 10 and 20 interposed therebetween. That is, the light source 30, the end portions of the bare fibers 10a and 20a, and the CCD camera 32 are arranged in this order in the +Y direction. Accordingly, when light is projected from the light source 30 onto the end portions of the bare fibers 10a and 20a held in the V grooves 50a and 50b, the CCD camera 32 can capture a transmitted-light image of the end portions of the bare fibers 10a and 20a.

The discharge power supply unit 42, which is equipped with the pair of discharge electrode rods 40a and 40b, is supported on the support member 44 fixed to the base 70. The discharge electrode rods 40a and 40b are disposed opposite each other with the end portions of the bare fibers 10a and 20a interposed therebetween. The pair of discharge electrode rods 40a and 40b are supplied with a high voltage from the discharge power supply unit 42 which is controlled by the control unit 80, and an arc discharge is produced between the discharge electrode rods 40a and 40b. The ends of the bare fibers 10a and 20a are melted by the heat of the arc discharge.

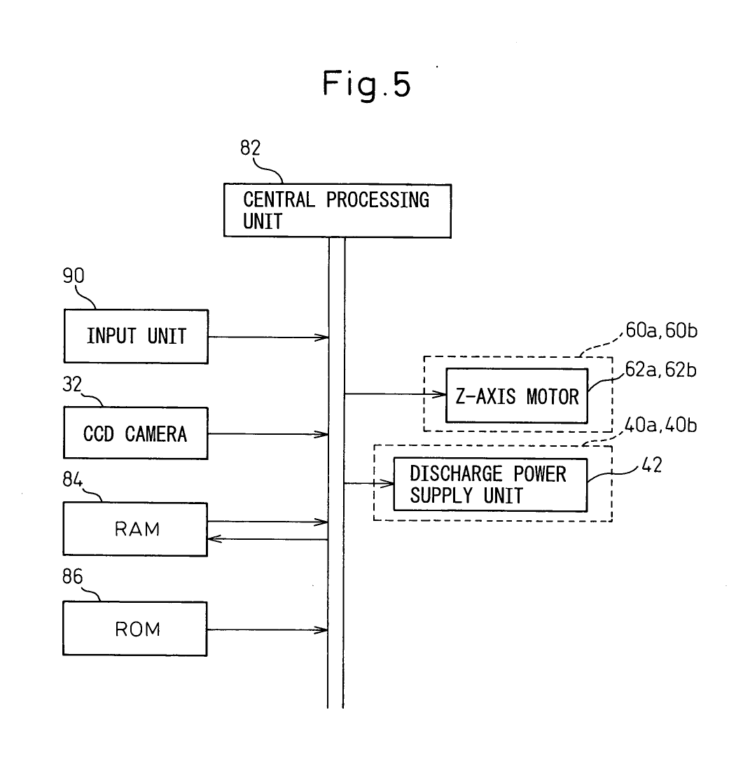

FIG. 5 is a control system block diagram showing the control unit 80 according to the embodiment of the present invention, along with the input-side units (CCD camera 32, input unit 90) that supply information to the control unit 80 and the output-side units (Z-axis motors 62a and 62b, discharge power supply unit 42) that are supplied with information from the control unit 80. The input unit 90 as an input-side unit is used to manually issue a command directly to a central processing unit 82, and can issue, for example, a start command and an emergency stop command for the operation of the optical fiber splicing apparatus 1. The control unit 80 comprises a RAM 84 and a ROM 86 in addition to the central processing unit 82. The ROM 86 holds the amount of discharge energy that matches the condition of the splicing edge surface of each of the bare fibers 10a and 20a, the processing program and data needed for the central processing unit 82 to perform data processing operations, and the control program and data needed for the central processing unit 82 to perform the apparatus control operations. Here, the amount of discharge energy can be expressed as the product of electric current (mA) and discharge time (msec). The RAM 84 has a memory area for temporarily storing data such as the amount of discharge energy loaded from the ROM 86 and imaging data loaded from the CCD camera, and a work area used, for example, when performing mathematical operations for uniquely determining the condition of the splicing edge surface of each of the bare fibers 10a and 20a. The central processing unit 82 performs data processing operations in accordance with the processing program loaded from the ROM 86, and also performs apparatus control operations in accordance with the control program to control the entire operation of the optical fiber splicing apparatus 1. For example, the central processing unit 82 writes the imaging data output from the CCD camera 32 into the RAM 84 and, while reading the processing program held in the ROM 86, performs the desired processing on the imaging data. Based on the information obtained from this processing, the central processing unit 82 controls the rpms of the Z-axis motors 62a and 62b to move the moving stages 60a and 60b, and controls the discharge power supply unit 42 to adjust the amount of discharge energy of the arc discharge to be produced between the discharge electrode rods 40a and 40b.

Next, a description will be given of an optical fiber splicing method according to the present embodiment that uses the thus configured optical fiber splicing apparatus 1. Generally, to place an object in an arbitrary position in space and hold it in a desired orientation, adjustments based on the rectilinear motions along the orthogonal coordinate axes X, Y, and Z and adjustments based on the rotational motions about the respective axes are needed. In the positioning of the bare fibers 10a and 20a of the optical fibers 10 and 20 according to the present embodiment, adjustments based on the rectilinear motions along the X- and Y-axes and adjustments based on the rotational motions about the respective axes are already made when installing the V grooves 50a and 50b and the moving stages 60a and 60b. Accordingly, when joining together the bare fibers 10a and 20a of the optical fibers 10 and 20, adjustments based on the rectilinear motion along the Z-axis need only be performed.

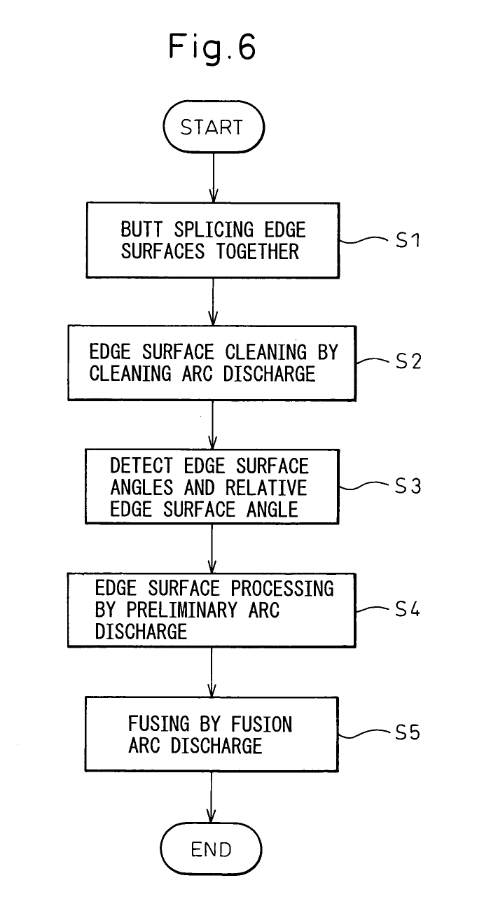

FIG. 6 is a flowchart for explaining the splicing method according to the present embodiment. As shown in FIG. 4, the optical fibers 10 and 20 to be spliced together are held fixed in the respective holders 52a and 52b, and the bare fibers 10a and 20a are placed in the respective V-grooves 50a and 50b. Then, the operation of the optical fiber splicing apparatus 1 is started via the input unit 90, and the central processing unit 82 drives the Z-axis motors 62a and 62b, causing the moving stages 60a and 60b to move toward each other. As a result, the splicing edge surfaces of the bare fibers 10a and 20a are butted together, and an adjustment is made so that the axis of the pair of discharge electrode rods 40a and 40b is located approximately at the center between the ends of the bare fibers 10a and 20a (step S1).

When the moving of the moving stages 60a and 60b is completed, the central processing unit 82 drives the discharge power supply unit 42 based on the cleaning electric current value and cleaning discharge time stored in the ROM 86. By thus driving the discharge power supply unit 42, a weak cleaning arc discharge is produced between the pair of discharge electrode rods 40a and 40b, and the splicing edge surfaces of the bare fibers 10a and 20a are cleaned (step S2).

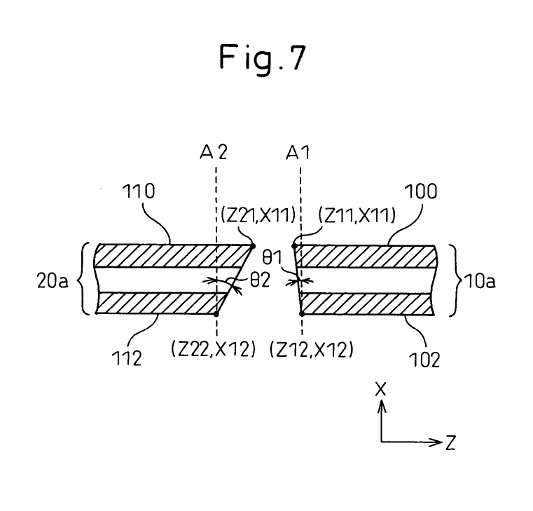

When the edge surface cleaning of the bare fibers 10a and 20a is completed, the edge surface angles of the bare fibers 10a and 20a and their relative edge surface angles are respectively obtained (step S3). FIG. 7 shows a transmitted-light image, captured by the CCD camera 32, of the end portions of the bare fibers 10a and 20a of the optical fibers 10 and 20; as shown, the axial center of each of the bare fibers 10a and 20a is parallel to the Z-axis. In the present embodiment, it is assumed that the diameters of the cross sections cut perpendicularly to the axes of the bare fibers 10a and 20a, respectively, are equal to each other. Hatched portions indicate low-brightness portions; since the low-brightness portions occur in areas near both sides of each of the bare fibers 10a and 20a along the axial direction thereof, these portions can be generally regarded as representing the side portions of the bare fibers 10a and 20a. Accordingly, utilizing the low-brightness portions of the transmitted-light image captured by the CCD camera 32, the edge surface angles of the bare fibers 10a and 20a can be obtained by performing the following operation. The coordinates (Z11, X11) of an end of an upper low-brightness line 100 and the coordinates (Z12, X12) of an end of a lower low-brightness line 102 in the transmitted-light image of the bare fiber 10a are stored in the RAM 84; likewise, the coordinates (Z21, X11) of an end of an upper low-brightness line 110 and the coordinates (Z22, X12) of an end of a lower low-brightness line 112 in the transmitted-light image of the bare fiber 10a are stored in the RAM 84. Here, since the axes of the bare fibers 10a and 20a are already aligned with respect to the X-axis direction when installing the V grooves 50a and 50b, the X coordinates of the ends of the upper low-brightness lines 100 and 110 and the X coordinates of the ends of the lower low-brightness lines 102 and 112 of the bare fibers 10a and 20a, respectively, have the same values. Generally, if θ is a minuscule angle, an approximation θ≈tan θ holds. Accordingly, the edge surface angle θ1 of the bare fiber 10a can be obtained by calculating (Z11−Z12)/(X11−X12). Likewise, the edge surface angle θ2 of the bare fiber 20a can be obtained by calculating (Z21−Z22)/(X11−X12). Here, the sign of θ1, θ2 is positive (+) when θ1, θ2 is formed in the right-hand side relative to a line segment A1, A2 extending parallel to the X-axis, and is negative (−) when θ1, θ2 is formed in the left-hand side relative to A1, A2. Finally, the relative edge surface angle θr=|θ1−θ2| between the bare fibers 10a and 20a is obtained.

After obtaining the edge surface angles of the bare fibers 10a and 20a and their relative edge surface angle, the edge surfaces are processed by a preliminary arc discharge (step S4). In the edge surface processing step, the central processing unit 82 drives the discharge power supply unit 42 based on the preliminary electric current value and preliminary discharge time stored in the ROM 86 for the relative edge surface angle. Here, even when the edge surface angles θ1 and θ2, respectively, are not 0, the splice loss can be reduced to a certain extent as long as the splicing edge surfaces of the bare fibers 10a and 20a are made parallel to each other; therefore, in the present embodiment, the edge surfaces are processed based on the relative edge surface angle θr which indirectly expresses the parallelism between the two splicing edge surfaces. When the preliminary arc discharge is produced between the pair of discharge electrode rods 40a and 40b by driving the discharge power supply unit 42, the splicing edge surfaces of the bare fibers 10a and 20a are melted at portions where the gap between the edge surfaces is narrow. The melted portions then recede relative to each other while being rounded due to surface tension. As a result of this edge surface processing, the splicing edge surfaces of the bare fibers 10a and 20a are made substantially parallel to each other, eliminating the difference between the edge surface angles θ1 and θ2 of the bare fibers 10a and 20a. In the present embodiment, the preliminary electric current value is fixed to 14 mA, and only the preliminary discharge time is varied according to the value of the relative edge surface angle.

When the edge surface processing with the preliminary arc discharge is completed, fusing is performed using a fusion arc discharge (step S5). In the fusing step, the central processing unit 82 drives the discharge power supply unit 42 based on the fusion electric current value and fusion discharge time stored in the ROM 86 for the kind of the optical fiber used. Further, the central processing unit 82 drives the Z-axis motors 62a and 62b, causing the moving stages 60a and 60b to move closer to each other. By operating the discharge power supply unit 42, a fusion arc discharge is produced between the pair of discharge electrode rods 40a and 40b and, by driving the Z-axis motors 62a and 62b, the splicing edge surfaces of the bare fibers 10a and 20a are pushed against each other and are thus joined together. In the present embodiment, while maintaining the fusion electric current value at the same value as the preliminary electric current value used in step S4, the fusion arc discharge is produced for the duration of the fusion discharge time (usually, about 1.5 seconds) stored in the ROM 86 for the kind of the optical fiber used.

That is, the splicing edge surfaces of the two fibers to be spliced together are butted against each other, and an adjustment is made so that the axis of the pair of discharge electrode rods is located at the center between the splicing edge surfaces of the two fibers (step S1); a cleaning arc discharge is applied to clean the splicing edge surface of each fiber (step S2); the edge surface angle that the splicing edge surface of each fiber makes with the cross section cut perpendicularly to the fiber axis is detected along with the relative edge surface angle which represents the difference between the edge surface angles of the two fibers (step S3); a preliminary arc discharge having the amount of discharge energy that matches the detected relative edge surface angle is applied to melt and shape the splicing edge surface of each fiber (step S4); and finally, a fusion arc discharge is applied to accomplish the fusion splicing (step S5). With this method, even when the edge surface angle of each of the two fibers to be spliced together, or their relative edge surface angle, has a large value, the fusion splicing of the two fibers can be performed by reducing splice loss, without suspending the splicing operation.

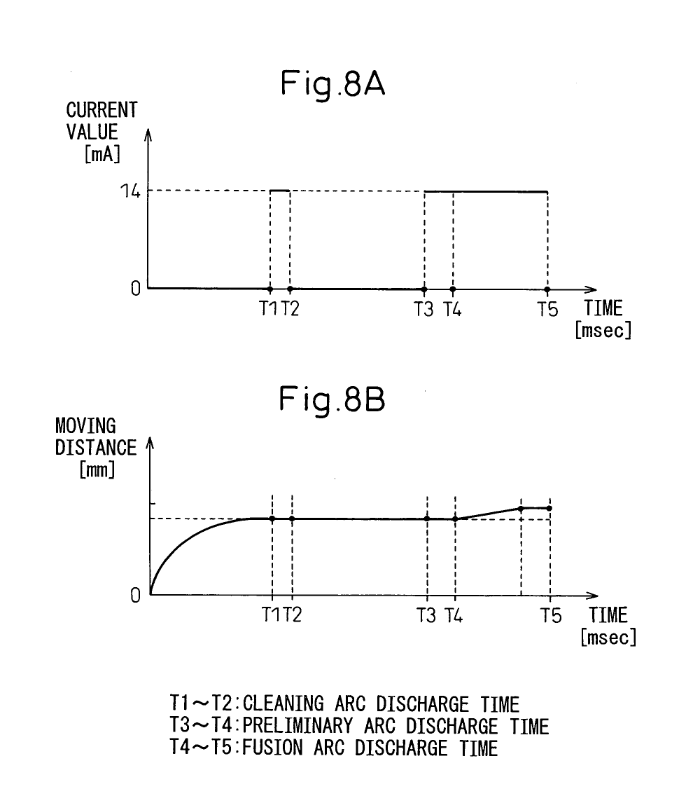

FIGS. 8A and 8B are diagrams showing along a time axis the variation of the electric current supplied from the discharge power supply unit 42 to the pair of discharge electrode rods 40a and 40b and the variation of the moving distance of the bare fiber 10a in the above-described splicing method. Here, step S1 is performed in the section between 0 and T1, step S2 is performed in the section between T1 and T2, step S3 is performed in the section between T2 and T3, step S4 is performed in the section between T3 and T4, and step S5 is performed in the section between T4 and T5. Referring to FIG. 8A, a description will be given of how the electric current value changes as the time progresses. The cleaning electric current value in step S2, the preliminary electric current value in step S4, and the fusion electric current value in step S5 are the same, i.e., 14 mA. The discharge time increases in the order of the cleaning discharge time in step S2, the preliminary discharge time in step S4, and the fusion discharge time in step S5. The amount of discharge energy can be expressed as the product of the electric current (mA) and the discharge time (msec); therefore, for the cleaning arc discharge, a small amount of discharge energy just sufficient to clean the splicing edge surfaces is used. For the preliminary arc discharge, the amount of discharge energy just sufficient to melt the splicing edge surfaces is used, while for the fusion arc discharge, the amount of discharge energy necessary to accomplish the fusion splicing of the splicing edge surfaces is used. The preliminary arc discharge is immediately followed by the fusion arc discharge.

Referring to FIG. 8B, a description will be given of how the moving distance of the bare fiber 10a changes as the time progresses. It will be appreciated that the moving distance of the bare fiber 20a also changes in a similar manner. The bare fiber 10a is moved in steps S1 and S5. In step S1, first the bare fiber 10a is moved by a large amount, and the position of the bare fiber 10a is roughly adjusted so that the axis of the pair of discharge electrode rods 40a and 40b is located approximately at the center between the ends of the bare fibers 10a and 20a. After that, the bare fiber 10a is moved in small increments relative to the bare fiber 20a to finely adjust the position of the bare fiber 10a so that the axis of the pair of discharge electrode rods 40a and 40b is located at the center between the ends of the bare fibers 10a and 20a. By moving the bare fiber 10a in this manner in step S1, the edge surface of the bare fiber 10a is butted against the edge surface of the bare fiber 20a. In step S5, to fuse the edge surface of the bare fiber 10a with the edge surface of the bare fiber 20a, the edge surface of the bare fiber 10a is pushed into the edge surface of the bare fiber 20a by gradually moving the bare fiber 10a during the fusion arc discharge. At this time, the edge surface of the bare fiber 20a also is pushed into the edge surface of the bare fiber 10a. After a while, the pushing of the bare fiber 10a ends, stopping at that position for a prescribed time in order to stabilize the fused condition of the bare fibers 10a and 20a. During the cleaning arc discharge in step S2 and during the preliminary arc discharge in step S4, the bare fiber 10a is not moved and, while holding the bare fiber 10a stationary, the edge surface cleaning and the edge surface processing are respectively performed.

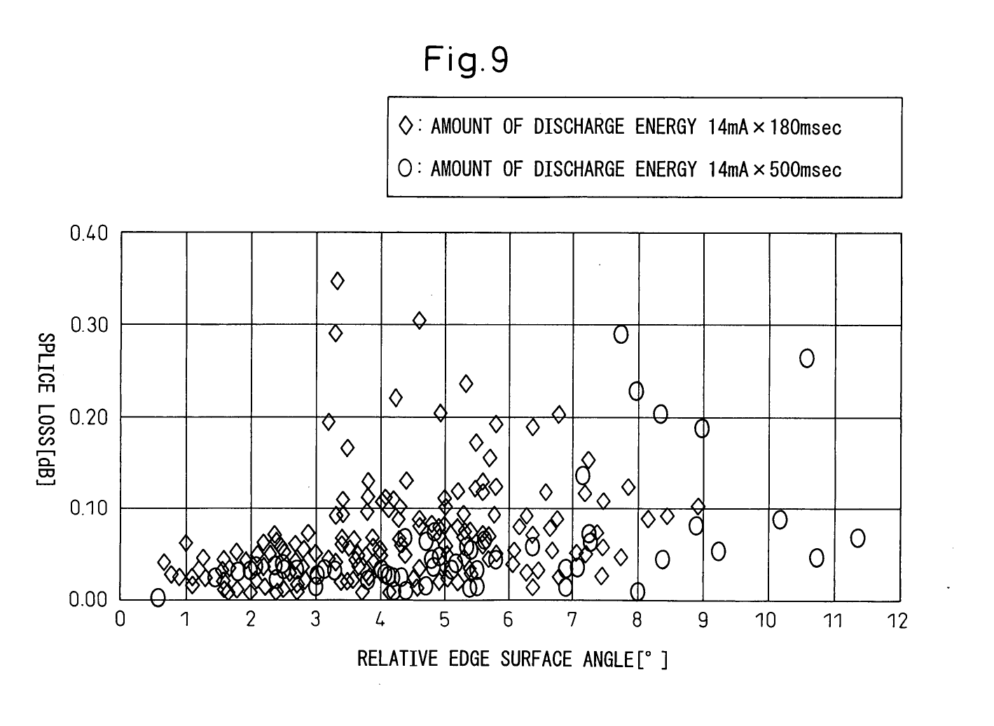

Next, a detailed description will be given of the correspondence between the relative edge surface angle and the amount of discharge energy in step S4. FIG. 9 is a graph showing the relationship between the relative edge surface angle and the splice loss in a fiber whose edge surface angle easily tends to affect the splice loss, such as used in a coupler or the like, for two different amounts of discharge energy. According to the results of the measurements taken of this fiber, to suppress the splice loss to within 0.1 dB which is a typical tolerance limit of splice loss, the relative edge surface angle must be reduced to 3° or less in the case of the amount of discharge energy=14 mA×180 msec, while in the case of the amount of discharge energy=14 mA×500 msec, the relative edge surface angle must be reduced to 7° or less. Accordingly, good splicing performance can be obtained if the relative edge surface angle is held within the above-given limits for the respective amounts of discharge energy.

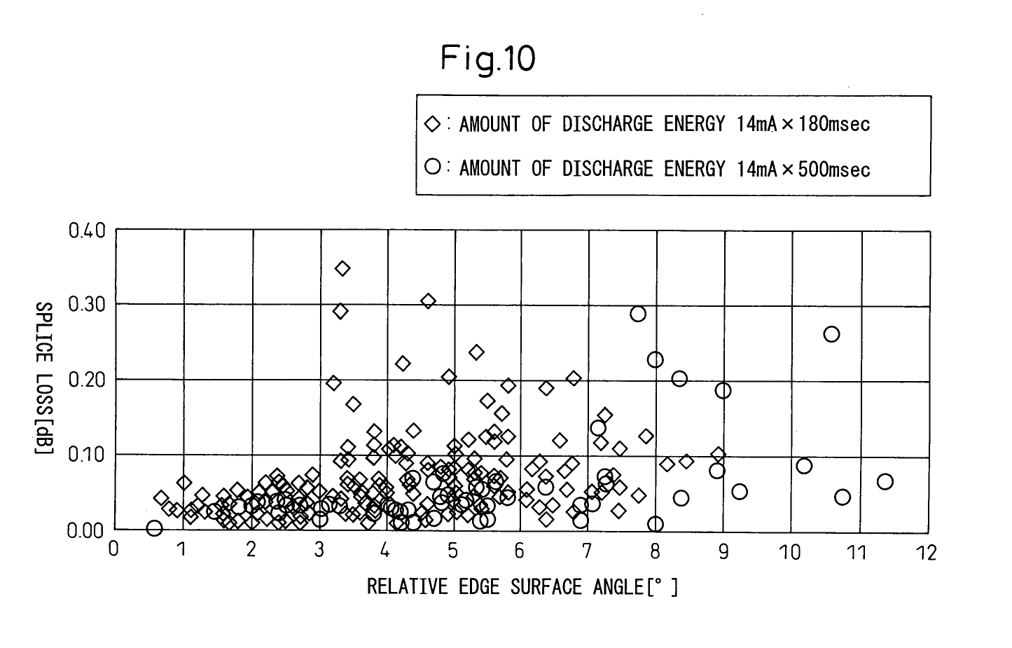

FIG. 10 is a graph likewise showing the relationship between the relative edge surface angle and the splice loss in a standard single-mode fiber for two different amounts of discharge energy. According to the results of the measurements taken of this fiber, to suppress the splice loss to within 0.1 dB which is a typical tolerance limit of splice loss, the relative edge surface angle must be reduced to 3° or less in the case of the amount of discharge energy=14 mA×180 msec, while in the case of the amount of discharge energy=14 mA×500 msec, the relative edge surface angle must be reduced to 7° or less. Accordingly, good splicing performance can be obtained if the relative edge surface angle is held within the above-given limits for the respective amounts of discharge energy.

As can be seen from the graph shown in FIG. 9 or 10, as the amount of discharge energy is made larger, the upper limit of the relative edge surface angle, within which the splice loss can be suppressed to 0.1 dB or less, can be raised. In view of this, as a method for obtaining good splicing performance at any relative edge surface angle, a method may be employed that does not perform step S3 for detecting the edge surface angles and the relative edge surface angle, but generates an arc discharge having a large amount of discharge amount from the beginning and applies such an arc discharge to the splicing edge surfaces in the edge surface processing step S4. According to this method, since the edge surface angles and the relative edge surface angle need not be detected, it is expected that the splicing of the two fibers can be accomplished in a shorter time. However, if a preliminary arc discharge having a large amount of discharge amount is applied from the beginning to an optical fiber whose edge surface angle is small, distortion occurs in the shape of the joint where the fibers are joined together.

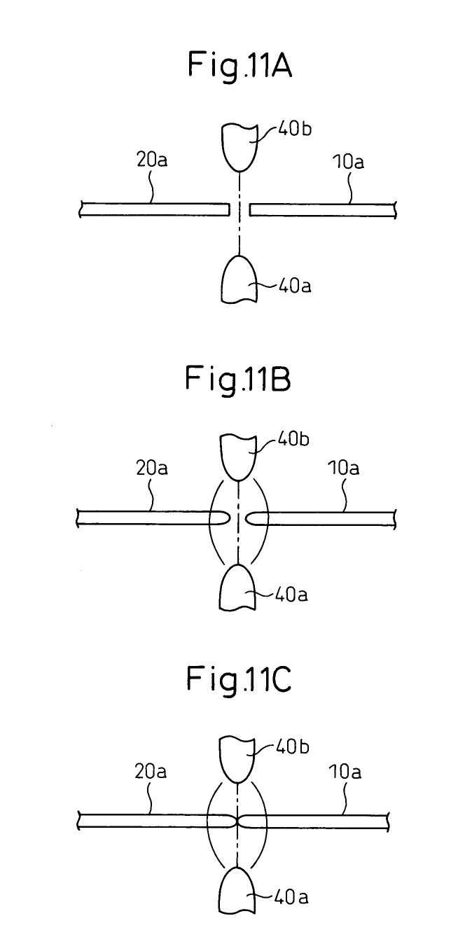

FIGS. 11A, 11B, and 11C show how the shape of the fiber joint becomes deformed. When the edge surface angle of each fiber is small, as shown in FIG. 11A, if a preliminary arc discharge having a large amount of discharge amount is applied, the edge surface of each fiber is excessively rounded, as shown in FIG. 11B. If the two fibers are spliced together in this condition, the shape of the joint is deformed as shown in FIG. 11C. As a result, while the splice loss due to the edge surface angles can be reduced, a new splice loss arises due to the deformed joint shape.

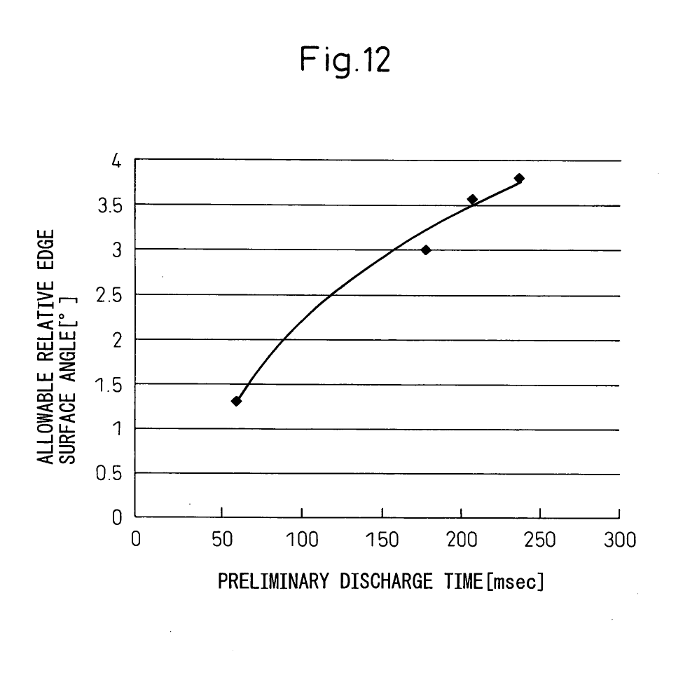

In view of this, the following method may be employed as one possible method that can prevent the occurrence of the splice loss due to the deformation of the joint shape, while also suppressing the splice loss due to the edge surface angles by using the measurement results shown in FIGS. 9 and 10. That is, prior to the splicing operation, the relationship between the relative edge surface angle and the splice loss for the kind of the optical fibers to be spliced together is obtained for various amounts of discharge energy, and the upper limit of the relative edge surface angle, within which the splice loss can be suppressed to 0.1 dB or less, that is, the allowable relative edge surface angle, is computed. Referring to FIG. 9, for example, the allowable relative edge surface angle is 3° in the case of the amount of discharge energy=14 mA×180 msec, and 7° in the case of the amount of discharge energy=14 mA×50 msec. In this way, the allowable relative edge surface angle is computed for each amount of discharge energy, and the relationship between the amount of discharge energy and the allowable relative edge surface angle is prestored in the ROM 86. FIG. 12 is a graph of a function F defining the relationship between the preliminary discharge time and the allowable relative edge surface angle in a fiber whose edge surface angle easily tends to affect the splice loss, such as used in a coupler or the like as used in FIG. 9. Generally, the amount of discharge energy can be expressed as the product of the electric current value and the discharge time; in the present embodiment, since the electric current value in each discharge operation is fixed to 14 mA, the amount of discharge energy varies in proportion to the discharge time. Therefore, in the present embodiment, the relationship between the preliminary discharge time and the allowable relative edge surface angle, to be stored in the ROM 86, can be expressed in the form of the function F defining the relationship between the preliminary discharge time and the allowable relative edge surface angle as shown in FIG. 12.

The operation of the central processing unit 82, in the edge surface processing step using the function F, will be described in detail below. In step S4 shown in FIG. 6, the function F corresponding to the kind of the fibers to be spliced together, the kind being previously input via the input unit 90, is loaded from the ROM 82 into the work area of the RAM 84 and, by regarding the relative edge surface angle obtained in step S3 as being the allowable relative edge surface angle, the preliminary discharge time is computed by referring to the function F. Then, the preliminary arc discharge is produced by driving the discharge power supply unit 42 for the duration of the thus computed preliminary discharge time. When the preliminary discharge time ends, then the fusion arc discharge is produced for the duration of the fusion discharge time while maintaining the electric current at the same value (14 mA), and the splicing is performed by driving the Z-axis motors 62a and 62b, causing the splicing edge surfaces of the bare fibers 10a and 20a to push against each other. Here, the form of the function F is not limited to the continuous function in which the relationship between the preliminary discharge time and the allowable relative edge surface angle varies continuously as shown in FIG. 12, but a step function may be employed which maintains the same preliminary discharge time until the allowable relative edge surface angle reaches a prescribed threshold value.

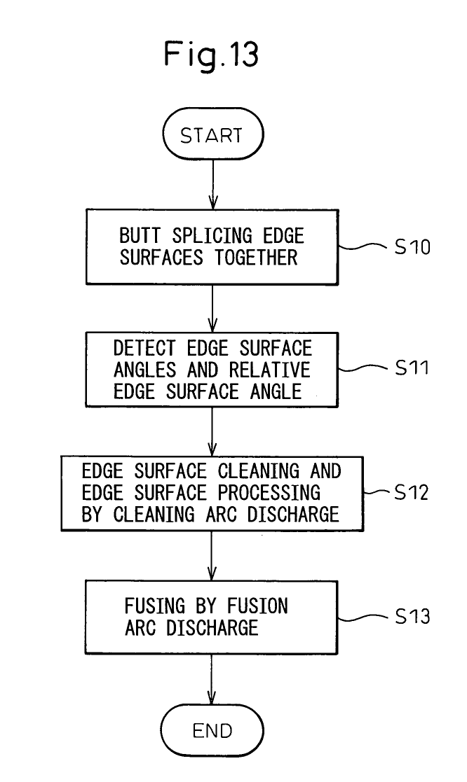

As a first modified example of the present embodiment, the edge surface processing may be performed simultaneously with the edge surface cleaning performed with the cleaning arc discharge. FIG. 13 is a flowchart for explaining the splicing method according to the modified example of the present embodiment. First, the operation of the optical fiber splicing apparatus 1 is started via the input unit 90, and the central processing unit 82 drives the Z-axis motors 62a and 62b, causing the splicing edge surfaces of the bare fibers 10a and 20a to butt against each other (step S10); then, the edge surface angles of the bare fibers 10a and 20a and their relative edge surface angle are respectively obtained (step S11). Here, the method of obtaining the edge surface angles and the relative edge surface angle is the same as that employed in the previously described step S3. When the edge surface angles of the bare fibers 10a and 20a and their relative edge surface angle are respectively obtained, the edge surface cleaning and the edge surface processing are performed using the cleaning arc discharge (step S12). The central processing unit 82 drives the discharge power supply unit 42 based on the cleaning electric current value and cleaning discharge time stored in the ROM 86 for the relative edge surface angle. By thus driving the discharge power supply unit 42, the cleaning arc discharge is produced between the pair of discharge electrode rods 40a and 40b, and the splicing edge surfaces of the bare fibers 10a and 20a are cleaned and melted simultaneously. The splicing edge surfaces of the bare fibers 10a and 20a are melted at portions where the gap between the edge surfaces is narrow, and the melted portions recede relative to each other while being rounded due to surface tension. As a result of this edge surface processing, the splicing edge surfaces of the bare fibers 10a and 20a are made substantially parallel to each other. When the edge surface processing with the cleaning arc discharge is completed, fusing is performed using the fusion arc discharge (step S13). By performing the edge surface processing simultaneously with the cleaning by using the cleaning arc discharge, the splicing of the two fibers can be accomplished in a shorter time.

As a second modified example of the present embodiment, the amount of discharge energy for performing the edge surface processing may be determined based on the edge surface angles, not on the relative edge surface angle. When the amount of discharge energy is determined based on the edge surface angles, since the edge surface angles, θ1 and θ2, of the bare fibers 10a and 20a can be respectively adjusted to 0, a further reduction in splice loss can be expected.

As a third modified example of the present embodiment, the amount of discharge energy for performing the edge surface processing may be determined based on the amount of chipping at the splicing edge surface of each bare fiber, not on the relative edge surface angle.

As a fourth modified example of the present embodiment, to control the amount of discharge energy, the electric current value may be varied while holding the discharge time fixed, instead of varying the discharge time while holding the electric current value fixed. When the amount of discharge energy is controlled by varying the electric current value while holding the discharge time fixed, the splicing of the two fibers can be accomplished in a shorter time because the discharge time can be set to a smaller value.

As described in detail above, according to the optical fiber edge surface processing method in the first aspect of the present invention, splice loss can be reduced in a simple manner, even when the edge surface angle of each optical fiber, or the relative edge surface angle between the two optical fibers, or the amount of chipping at the splicing cross section of each optical fiber, is large. Further, according to the optical fiber edge surface processing method in the first aspect of the present invention, splice loss can be reduced in a simple manner and in a short time, even when the edge surface angle of each optical fiber or the relative edge surface angle between the two optical fibers is large, or when the amount of chipping at the splicing cross section of each optical fiber is large.

Likewise, according to the optical fiber edge surface processing apparatus in the second aspect of the present invention, splice loss can be reduced in a simple manner, even when the edge surface angle of each optical fiber, or the relative edge surface angle between the two optical fibers, or the amount of chipping at the splicing cross section of each optical fiber, is large. Further, according to the optical fiber fusion splicing method in the third or fourth aspect of the present invention, or according to the optical fiber fusion splicing apparatus in the fifth aspect of the present invention, even when the edge surface angle of each optical fiber, or the relative edge surface angle between the two optical fibers, or the amount of chipping at the splicing cross section of each optical fiber, is large, the two optical fibers can be fusion spliced together by reducing splice loss in a simple manner.

Many different embodiments of the present invention may be constructed without departing from the spirit and scope of the present invention, and it should be understood that the present invention is not limited to the specific embodiments described in this specification, except as defined in the appended claims.

1. An optical fiber edge surface processing method comprising:
capturing a transmitted-light image of end portions of two optical fibers placed facing each other, and extracting, based on a brightness distribution in said transmitted-light image, edge surface information of each of said two optical fibers to be spliced together;
selecting a discharge condition corresponding to said edge surface information from among a plurality of discharge conditions prestored in a storage means; and
melting the splicing edge surfaces of said two optical fibers in accordance with said selected discharge condition, and thereby shaping said splicing edge surfaces.

2. The optical fiber edge surface processing method as claimed in claim 1, wherein said edge surface information concerns an edge surface angle that the splicing edge surface of each of said optical fibers makes with a plane perpendicular to the axial center of said optical fiber, and said discharge condition defines the amount of discharge energy necessary to melt the splicing edge surface of said optical fiber so as to reduce splice loss attributable to said edge surface angle.

3. The optical fiber edge surface processing method as claimed in claim 2, wherein said amount of discharge energy varies continuously or in steps in correlation with the magnitude of said edge surface angle.

4. The optical fiber edge surface processing method as claimed in claim 1, wherein said edge surface information concerns a relative edge surface angle which represents a difference between a first edge surface angle that the splicing edge surface of one of said two optical fibers makes with a plane perpendicular to the axial center of said one optical fiber and a second edge surface angle that the splicing edge surface of the other optical fiber makes with a plane perpendicular to the axial center of said other optical fiber, and said discharge condition defines the amount of discharge energy necessary to melt the splicing edge surface of said one optical fiber and the splicing edge surface of said other optical fiber so as to reduce splice loss attributable to said relative edge surface angle.

5. The optical fiber edge surface processing method as claimed in claim 4, wherein said amount of discharge energy varies continuously or in steps in correlation with the magnitude of said relative edge surface angle.

6. The optical fiber edge surface processing method as claimed in claim 1, wherein said edge surface information concerns the amount of chipping at the splicing edge surface of each of said optical fibers, and said discharge condition defines the amount of discharge energy necessary to melt the splicing edge surface of said optical fiber so as to reduce splice loss attributable to said amount of chipping.

7. The optical fiber edge surface processing method as claimed in claim 6, wherein said amount of discharge energy varies continuously or in steps in correlation with the magnitude of said amount of chipping.

8. An optical fiber edge surface processing apparatus comprising:
image capturing means for capturing a transmitted-light image of end portions of two optical fibers;
information extracting means for extracting edge surface information of each of said two optical fibers based on a brightness distribution in said transmitted-light image;
storage means for prestoring a plurality of discharge conditions;
selecting means for selecting a discharge condition corresponding to said edge surface information from among said plurality of discharge conditions; and
processing means for melting the splicing edge surfaces of said two optical fibers in accordance with said discharge condition selected by said selecting means, and thereby shaping said splicing edge surfaces.

9. An optical fiber fusion splicing method for fusion splicing two optical fibers together, comprising:
capturing a transmitted-light image of end portions of said two optical fibers placed facing each other, and extracting, based on a brightness distribution in said transmitted-light image, edge surface information of each of said two optical fibers to be spliced together;
selecting a splicing condition corresponding to said edge surface information from among a plurality of splicing conditions prestored in a storage means; and
producing a preliminary arc discharge in accordance with said selected splicing condition, thereby melting and shaping the splicing edge surfaces of said two optical fibers.

10. An optical fiber fusion splicing method for fusion splicing two optical fibers together, comprising:
capturing a transmitted-light image of end portions of said two optical fibers placed facing each other, and extracting, based on a brightness distribution in said transmitted-light image, edge surface information of each of said two optical fibers to be spliced together;
selecting a splicing condition corresponding to said edge surface information from among a plurality of splicing conditions prestored in a storage means; and
producing a cleaning arc discharge in accordance with said selected splicing condition, thereby melting and shaping the splicing edge surfaces of said two optical fibers.

11. An optical fiber fusion splicing apparatus for fusion splicing two optical fibers together, comprising:
image capturing means for capturing a transmitted-light image of end portions of said two optical fibers;
information extracting means for extracting edge surface information of each of said two optical fibers based on a brightness distribution in said transmitted-light image;
storage means for prestoring a plurality of splicing conditions;
selecting means for selecting a splicing condition corresponding to said edge surface information from among said plurality of splicing conditions;
discharging means for producing an arc discharge to be applied to the splicing edge surfaces of said two optical fibers; and
control means for controlling the amount of discharge energy of said arc discharge in accordance with said splicing condition selected by said selecting means.
